(19) United States
(12) Patent Application Publication
(10) Pub. No.: US 2016/0137481 A1
(43) Pub. Date: May 19, 2016

(54) MICROPROCESSOR-CONTROLLED BEVERAGE DISPENSER

(71) Applicant: Cleland Sales Corporation, Los Alamitos, CA (US)

(72) Inventors: Joe Chadwell, San Antonio, TX (US); James Cleland, Los Alamitos, CA (US); William Edwards, Selma, TX (US); Michael Romanszyn, San Antonio, TX (US)

(21) Appl. No.: 14/826,507

(22) Filed: Aug. 14, 2015

Related U.S. Application Data
(63) Continuation of application No. 12/716,949, filed on Mar. 3, 2010, now Pat. No. 9,243,830.
(60) Provisional application No. 61/157,031, filed on Mar. 3, 2009.

(51) Int. Cl. B67D 3/00

(52) U.S. Cl. CPC B67D 3/0009; B67D 3/0077

(57) ABSTRACT

A microprocessor-controlled beverage dispenser is disclosed, which provides a cold plate having disposed therein beverage lines and refrigerant lines. The refrigerant lines may be connected to a cooling or refrigeration system, including a heat exchanger. The beverage lines may be connected to a beverage supply for dispensing a desired beverage. Valves and pressure sensors in the refrigerant line are engaged with a microprocessor. If the temperature falls below a desired value, then the cooling system is shut off. This permits the microprocessor to closely control the temperature of the beverage being dispensed.

### CROSS REFERENCE TO RELATED APPLICATIONS

This application is a continuation of U.S. application Ser. No. 12/716,949, filed on Mar. 3, 2010, which claims priority to and the benefit of U.S. provisional application 61/157,031 filed Mar. 3, 2009. This and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### BACKGROUND

This application incorporates by reference both U.S. Provisional Patent Application Ser. No. 61/157,031 and U.S. Pat. No. 7,296,428, issued Nov. 20, 2007, to the extent that the specifications of these do not conflict with the specification set forth herein.

The device disclosed is related generally to beverage dispensing systems employing a cooling subsystem, more particularly, a self-contained tabletop beverage dispenser incorporating a refrigerant chilled cold plate for cooling a beverage.

When beer (or other beverage) is charged with a gas, such as a carbon dioxide, to move the beer through the various lines, the gas is entrained to dissolve in the fluid and resides in a stable state for temperatures at or below about 30° F. The gas typically does not bubble out of the fluid, but is carried in the fluid and gives a beverage a distinctive effervescence when consumed. However, as the temperature of the beer rises above about 30° F., absent increase in pressure on the system, the gas becomes increasingly unstable and begins to bubble or foam out of the flowing beer. Further warming of the beer increases the foaming effect, as the gas bubbles form and propagate downstream. Foaming is further exacerbated by disturbances in the beer, such as the turbulence generated when the beer is dispensed from the dispensing valve. When beer is warmed to 45° F. or more, such as when exposed to normal ambient room temperature, the gas becomes sufficiently unstable and so much foam is generated when it is dispensed that it often cannot be served to patrons. As a result, as waste increases, and profits decrease.

### OBJECTS OF THE INVENTION

One of the objects of the present invention is to prime a refrigeration system for restarting at a later time by drawdown on the suction end before the compressor is turned off.

### SUMMARY OF THE INVENTION

The present invention is directed to a beverage dispensing system for dispensing chilled beverages, the system comprising a housing with one or more beverage inlet connections extending from said housing and one or more beverage dispenser valves extending from said housing. A beverage cooling system is positioned within said housing, said cooling system comprising a reservoir capable of receiving a supply of refrigerant, a cold plate in fluid communication with said refrigerant reservoir, wherein the refrigerant lines extend through said cold plate, wherein beverage lines also extend through said cold plate adjacent to said refrigerant lines.

The cooling system further includes an accumulator, a compressor, a refrigerant condenser, and a thermal expansion valve positioned between said refrigerant reservoir and said cold plate to adjust the flow of refrigerant depending upon the temperature of the cold plate.

If freeze-up of the beverage in the beverage lines occurs, refrigerant may be controlled by means of a hot gas valve to divert the flow of refrigerant from the cold plate, adding hot gas from the high side of the compressor to the cold plate refrigerant inlet line. Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

A beer or beverage evaporator valve, typically a solenoid, is provided upstream of the accumulator and downstream of the cold plate. A liquid line valve is provided typically downstream of the condenser and upstream of the reservoir, also solenoid controlled. A thermal expansion valve is provided downstream of the reservoir upstream of and close to the refrigerant inlet of the cold plate, for metering refrigerant into the cold plate in response to a thermal bulb at the outlet of the refrigerant lines on the cold plate.

Electronic sensors, such as transducers (including thermal or pressure sensors), may be provided in conjunction with a microprocessor to control the operation of the system. In one embodiment, a temperature sensor (such as a thermistor) or pressure transducer is located upstream of the evaporator valve and a pressure transducer is located near the suction or low side of the compressor. When the system is energized, that is, in a “run” or “on” mode, the microprocessor will control the compressor. The microprocessor, responsive to the evaporator (cold plate) condition, will initiate a system shutoff when a predetermined psi, for example approximately 55 psi, is reached. The first step of the system shutoff will be to de-energize the normally closed beer evaporator and liquid line valves (thus closing them), thus “trapping” the refrigerant between the valves and in the evaporator and begin monitoring of the sensor at the low end of the compressor or suction side, continuing the compressor running until a predetermined pressure, for example about 10-35 psi, is sensed (thereby assuring the accumulator is void of liquid). At a compressor low end of 10-35 psi, the compressor de-energizes and the system will wait again for a signal from the transducer just downstream from the evaporator. When this transducer hits 70 psi or the associated temperature, the microprocessor will initiate an “on” command to the compressor will be turned on and the solenoids will be energized and opened.

Restated, the microprocessor, in response to a high set point (cold plate too warm) from the first transducer (just upstream of the beer evaporator valve and downstream of the cold plate), will energize the compressor and open the liquid line valve and the evaporator valve, and responsive to an intermediate set point (cold plate low temperature) from the first transducer will close the liquid line valve and evaporator valve, but keep the compressor going, and in response to a low set point from the second transducer (accumulator dry), de-energizes the compressor and goes back to begin the cycle, monitoring the first transducer for the high set point.

### BRIEF DESCRIPTION OF THE DRAWINGS

FIG. 1 is a perspective view of the tabletop unit showing the housing, the beverage outlets, and the spill tray.

FIG. 2 is an equipment layout, not to scale, showing the relative positions of the elements of Applicants' novel beer cooling system.

FIG. 2A is a block diagram illustrating the microprocessor inputs and outputs.

FIGS. 3 and 4 are perspective view of the equipment layout showing the elements of the cooling system in place with the housing cover removed therefrom.

FIG. 5 is an elevational view of the beverage or beer lines and refrigeration lines within the cold plate.

FIG. 6 is a perspective view of a layout for use with Applicants' novel beverage cooling system which shows a tabletop supporting the unit, which tabletop in turn is supported by legs or a cart or the like; the product here, two different beverages, are provided in feed lines to the rear of the housing of the unit.

FIG. 7 is a perspective view of the cold plate showing refrigeration lines and a pair of beer lines laying adjacent one another and embedded within an aluminum casting.

### DETAILED DESCRIPTION OF THE EMBODIMENTS

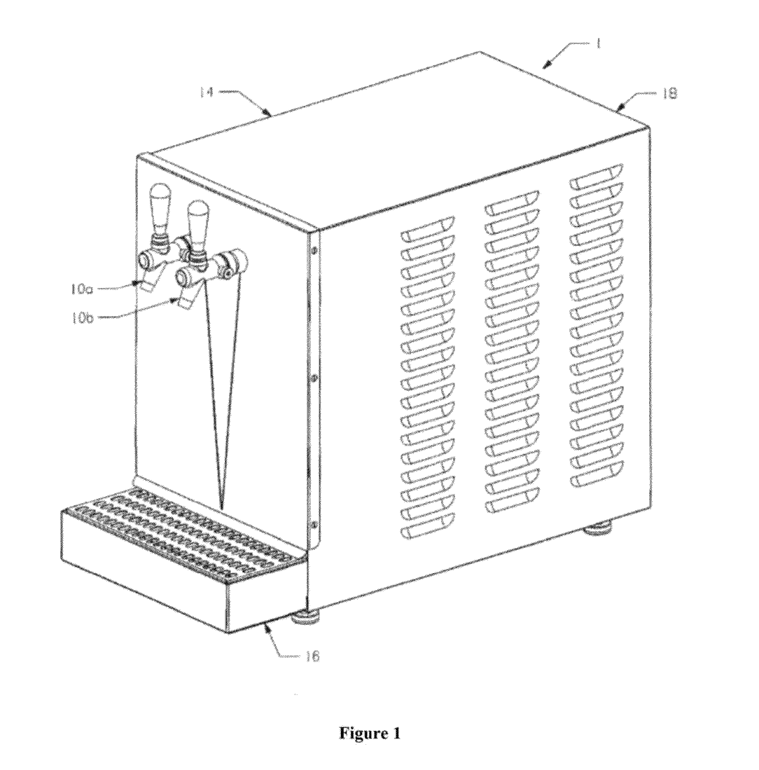

The standalone, self-contained beverage dispenser 10 of the present invention is shown in FIG. 1. Although the subject invention will be described in the context of the beverage to be dispensing being beer, it is to be understood the invention is not limited to the dispensing of beer. Beverage dispensing valves 10a and 10b stand out the front end of housing 14. The beverage dispensing outlets may be beer taps or other such dispensers as those known in the art. A beverage spill tray 16 is positioned beneath the outlets 10a and 10b. Beverage dispenser 1 may be mounted on a countertop, rolling cart or other support surface. The beverage dispenser I may be easily installed at a desired location. One needs simply to run the product lines from the beverage supply, for example, a beer keg, to the location for connection to the beverage dispensing unit.

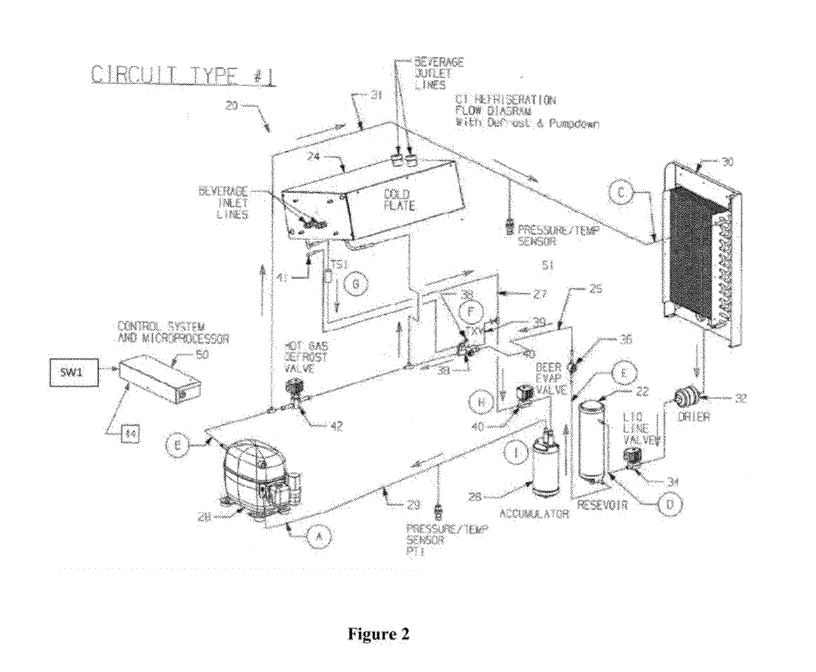

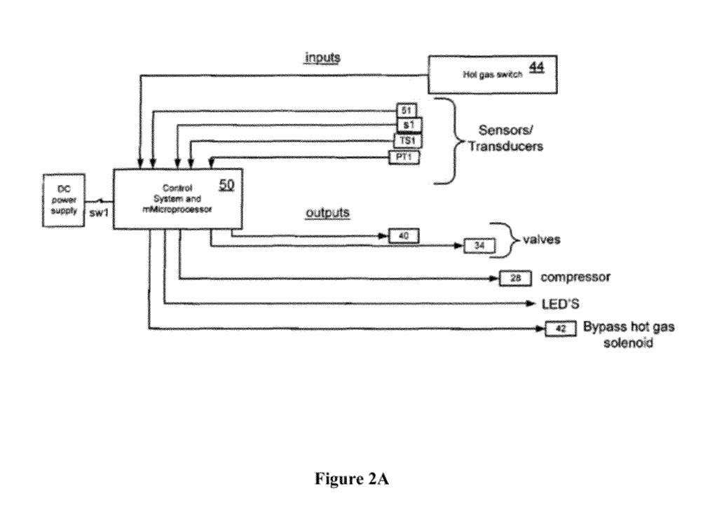

The refrigerant cooling system 20 of the subject invention is shown in FIG. 2. The cooling system 20 includes reservoir 22 which acts as the reservoir for the refrigerant, which is in fluid communication with cold plate 24 via refrigerant line 25. Refrigerant cooling lines acting as an evaporator, extend through cold plate 24 to cool corresponding beverage lines which also extend through cold plate 24. The cold plate utilized, including, for example, 40 pounds of cast aluminum, is a standard cold plate known to those skilled in the art wherein the beverage and refrigerant lines may be wound or located within the cold plate to increase the length of the lines positioned within said cold plate. The cooling system 20 also includes accumulator 26, compressor 28 and refrigerant condenser 30. As shown, refrigerant exits the cold plate 24 and flows to accumulator 26 via refrigerant line 27. From the accumulator 26, the refrigerant travels to the compressor 28 via refrigerant line 29. The refrigerant flows from the compressor 28 to the condenser 30 via refrigerant line 31.

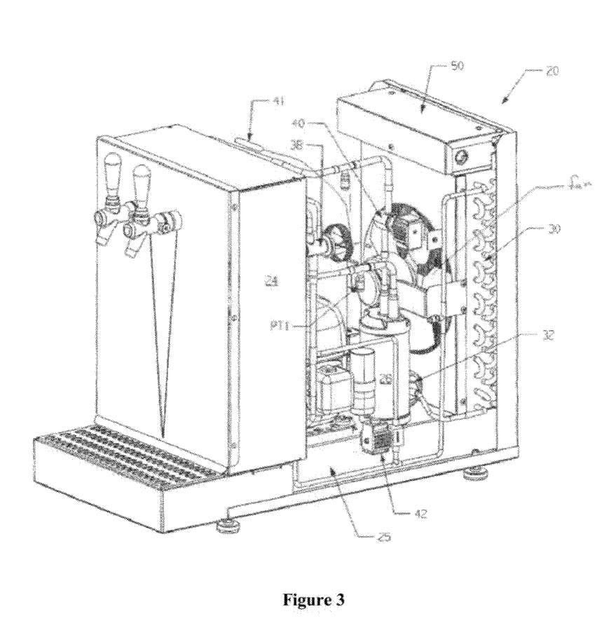

The operation of the refrigerant system is described below, in connection with FIGS. 2 and 3.

The refrigerant, which in a preferred embodiment is type 404a, enters the compressor 28 at point A as a low pressure gas and is discharged from the compressor as a high pressure gas at point B. It then enters the top of the condenser 30 at point C.

The refrigerant is cooled in the condenser, exiting it as a high pressure liquid, and passes through a drier 32 (which retains unwanted scale, dirt and moisture) to the liquid line valve 34, which is open whenever the cold plate 24 is warm enough to require cooling, as determined by a pressure switch Transducer TS 1 (pressure transducer or thermistor, for example).

The refrigerant, still in a high pressure liquid state, flows through the liquid line valve 34 and enters the reservoir tank 22, which serves as a storage or surge tank for the refrigerant at point D.

At point E, the refrigerant exits the reservoir tank, passes through a sight glass 36 (where bubbles will be observed if the system is low on refrigerant) and encounters the thermal expansion valve TXV 38.

A pressure differential is provided across the thermal expansion valve. This valve includes a sensor bulb that measures the degree (or lack) of superheat of the suction gas exiting the cold plate and expands or contracts to allow the flow of refrigerant to be varied according to need. The refrigerant leaving the thermal expansion valve will be in a low pressure liquid or liquid/vapor state when it enters the cold plate.

At the thermal expansion valve 38 there may also be a small equalizer tube 39 connected to the outlet cold plate 24. The equalizer tube 38 helps to equalize the pressure between the inlet and outlet side of the cold plate 24.

After passing through the thermal expansion valve 38, the refrigerant enters the cold plate 24 at point G. As the liquid or liquid/vapor refrigerant enters the cold plate it is subjected to a much lower pressure due to the suction created by the compressor and the pressure drop across the expansion valve. It will also be adjacent warmer beer lines. Thus, the refrigerant tends to expand and evaporate. In doing so, the liquid refrigerant absorbs energy (heat) from beverage lines within the cold plate 24.

The low pressure gas leaving the cold plate 24 encounters the evaporator valve 40, whose function is to trap refrigerant in the cold plate during system shutdown cycle. From the evaporator valve 40, the gas passes into accumulator 26, which help prevent any slugs of liquid refrigerant from passing directly into the compressor, and continues back to the compressor 28. The thermal expansion valve 38 mentioned above is used instead of a capillary tube in order to provide improved response to the cooling needs of the cold plate 24.

The microprocessor controlled electrical control system 50 is illustrated in FIGS. 2 and 2A. Refrigeration on/off switch SW 1 provides power to the entire system by manually depressing the switch. Pressure transducer PT1 monitors the refrigerant pressure in the compressor low side and cycles off the compressor and condenser fan (not shown) when the pressure drops to a predetermined level, 15 psi in a preferred embodiment, and cycles the compressor and fan back on when the temperature sensor or pressure transducer TS 1 reaches a second predetermined level, 75 psi in a preferred embodiment. TS 1 monitors refrigerant temperature (or pressure) just downstream of the beverage cold plate. When the pressure drops to a predetermined level, approximately 55 psi in a preferred embodiment, TS 1 through control system 50 cycles off the beverage evaporator coil or cold plate by shutting liquid line solenoid coil 34 and evaporator valve 40. The microprocessor then reads the transducer PT1 until drawdown to a lower pressure than 55 psi is reached, here for example, 10-35 psi, where the compressor is cycled off by the microprocessor/controller. The monitor then looks to TS 1. With the compressor off, the cold plate starts to warm. When the refrigerant pressure at TS 1 rises to a second predetermined level, approximately 72-75 psi in a preferred embodiment, the TS 1 through microprocessor/control system 50 turns on the compressor and opens evaporator solenoid coil 40 and liquid line solenoid 34. A push-button defrost switch 42 is provided to cycle on the hot gas solenoid and cycle off the condenser fan to deliver hot gas to the cold plate should the product in the cold plate become frozen.

Sensor/transducer TS1 responds to the cold plate 24 temperature by reading the pressure or temperature of the refrigerant as it is discharged from the cold plate. When the cold plate becomes warm enough, the liquid line valve 34 and the evaporator valve 40 open, thereby allowing refrigerant to flow throughout the system. When the cold plate becomes cool enough these valves 34/40 will close, trapping most refrigerant in the system but with the electronic control al lowing refrigerant to pump from the accumulator into the compressor down until PT1 reads about 15 psi (typically between 10-35 psi).

As shown in FIG. 2, defrost valve 42 is installed between the compressor discharge tube and the cold plate inlet. A manually operated momentary switch 44 may be deployed to trigger the defrost cycle. This signals the microprocessor to open the defrost valve 42 for a preset defrost cycle time, normally 30 seconds, and allows high pressure gas from the compressor to be pumped into the cold plate to thaw it, should it freeze up or get too cold. To prevent damaging the system, the switch should not be held longer than necessary.

The TXV 38 control s and meters the amount of refrigerant that flows into the evaporator based on the temperature with a sensing bulb 41 that is typically located on the suction line where it leaves the evaporator coil. The temperature differential of the evaporator inlet and outlet typically determines the opening and closing of the TXV 38 valve seat to either add refrigerant or constrict refrigerant flow to the evaporator. Other devices known in the art may control pressure of refrigerant into the evaporator.

An electronic microprocessor/controller 50 operates the compressor, condenser fan, and solenoids 34/40. The microprocessor controller engages a power off switch, a defrost switch 42, temperature sensor (from evaporator thermal sensor, a temperature sensor or pressure transducer) TS 1, and an overheat temperature sensor 51 (from high side of condenser), as well as a pressure/transducer PT 1 just upstream of the low end of the compressor.

Outputs (110 volt AC) include normally closed solenoids (2) 34/40, the compressor (typically about one-third horsepower) and the condenser fan (typically about 14 watt). Defrost solenoid 42 and a power on and defrost cycle LED include controller outputs.

In the on/run mode (when the power switch is activated), the compressor, condenser fan, and solenoid pair 34/40 are activated. Compressor pumps refrigerant and the temperature of the cold plate will drop as the refrigerant goes through the cold plate. The “power on” LED is on. The monitor is looking at TS 1 looking for the solenoid valves shutoff condition, the intermediate set point here, for example, about 55 psi.

“Stop” mode occurs when the intermediate set point evaporator temperature sensor TS 1 is reached, for example, approximately 29° F. (68.0 psi with Suva® 404A). The solenoids 34/40 are closed trapping liquid refrigerant in the cold plate and reservoir. The condenser fan and compressor continue to run until the pressure/vacuum transducer PT1 set point is reached. This is about 15 psi. This action assures that there is little or no liquid refrigerant left in the accumulator. At this point, the fan and the compressor turn off and wait for a microprocessor signal from the evaporator temperature sensor TS 1. “Power on” LED remains energized.

When temperature of the evaporator at TS 1 increases to an upper limit, typically about 33° F. (74.0 psi with 404A or other suitable refrigerant), the “on” mode is automatically activated by the controller and cycles the compressor on and the solenoids open.

This illustrates the controller in its normal operating mode. However, if the temperature of the high side thermal sensor 51 exceeds a set point (overheat), the system shuts down the compressor, fan, and solenoids and alternately flashes the LED indicators. This is a warning that the system has overheated.

If the system freezes up or gets too cold, the momentary “defrost” switch is activated. The defrost solenoid is activated and the defrost LED flashes for a defrost cycle. The cycle is timed to last about 15-20 seconds, after which the LED turns off and the dispenser returns to the normal on/run cycle.

One of the purposes of the electronic controller 50 is to maintain the compressor in an off position until the temperature of the evaporator reaches an upper limit, typically about 33° F., and the on mode is activated again. Thus, if there is any liquid refrigerant in the accumulator and it evaporates, as the system warms up or pressure increases, the pressure switch at the low end of the compressor will not cycle the compressor on. That is to say, the microprocessor controller 50 will provide for compressor run/on when solenoids 34/40 are de-energized and closed, but only until PT 1 reads about 15 psi or between about 10-35 psi, (thereby ensuring evaporation of any liquid refrigerant in accumulator 26).

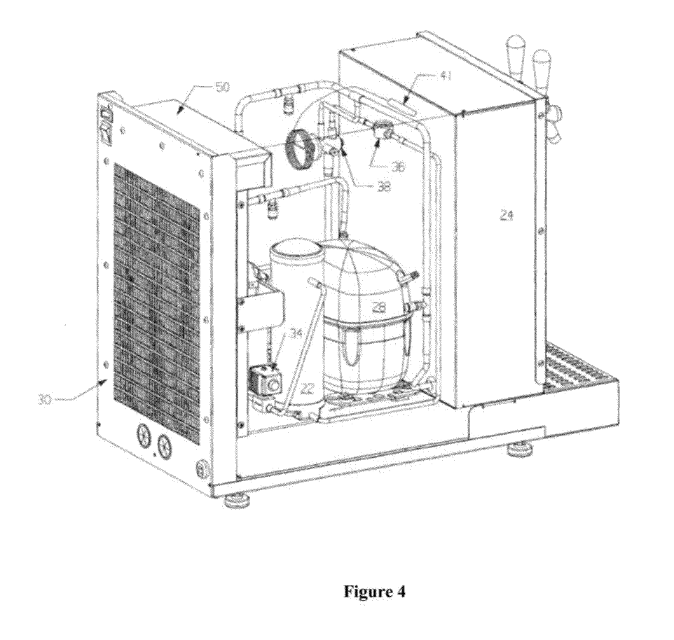

FIGS. 3 and 4 illustrate an equipment layout for the embodiment of Applicants' device as set forth in FIGS. 1 and 2. It is seen with respect to FIGS. 3 and 4, that the cold plate 24 is set vertically with respect to a base 25 of the cooling system 20. Furthermore, it can be seen that the condenser 30 is also set vertically and spaced apart from the cold plate 24. A substantial number of the elements are set between the vertically oriented cold plate and condenser, including the compressor, drier, solenoids, sight glass, liquid line valve, thermal control valve, evaporator valve, reservoir tank, and accumulator. Moreover, the fan for the condenser is mounted inside the unit exhausting air through vents in the rear view of the unit (see FIG. 4).

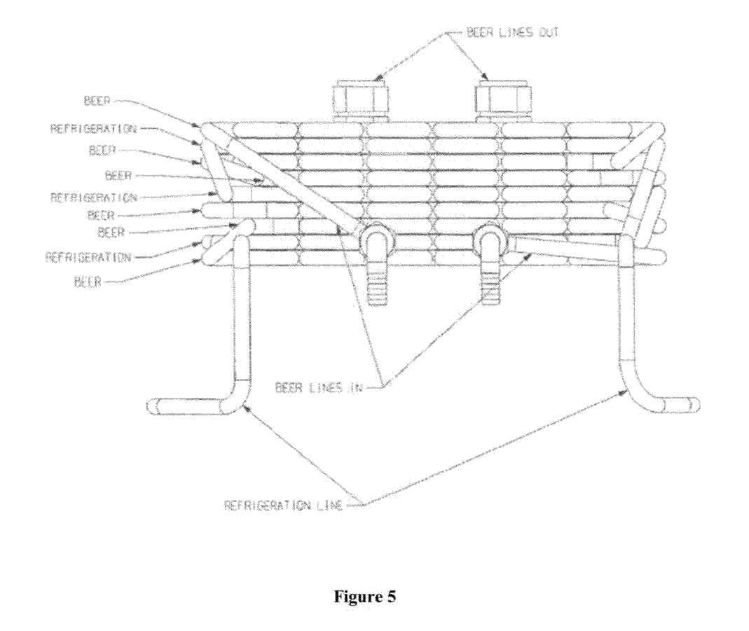

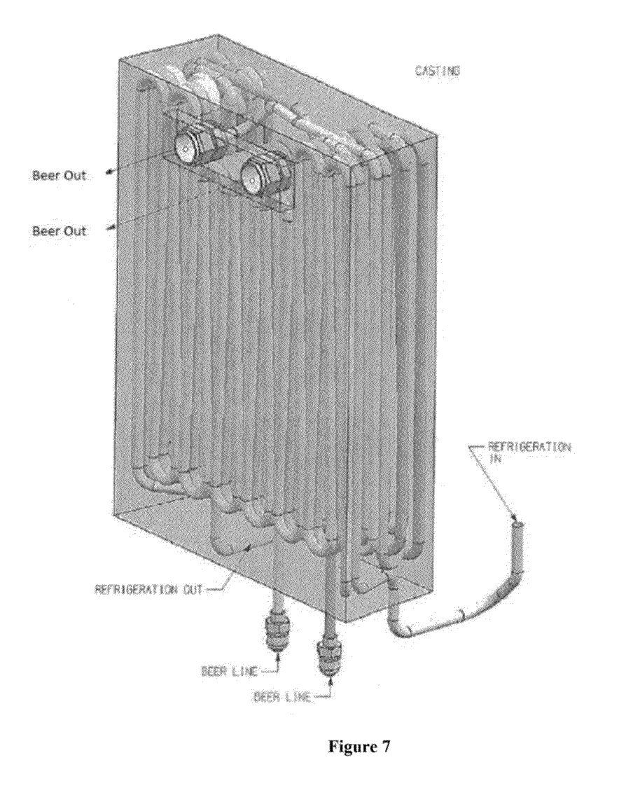

FIGS. 5 and 7 illustrate an embodiment of an arrangement of refrigeration lines and beer lines that may be used in the cold plate. It is seen with respect to FIG. 5 that refrigeration lines lay in a plane, as do the beverage lines. Adjacent to each beer line plane lays a refrigeration time plane for uniform heat transfer.

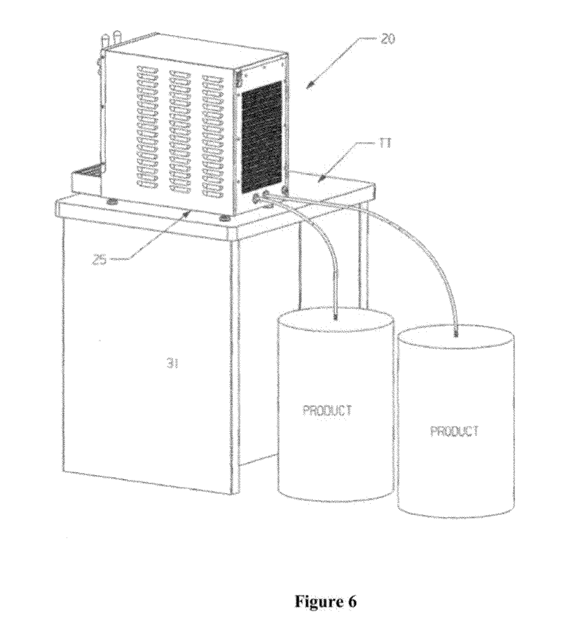

FIG. 6 illustrates a manner in which Applicants' novel cooling system 20 may be set up on a support surface or a table top TT, wherein the product (beverage) being supplied to the system, here from two kegs or other containers of liquid product, may enter the system from the rear. In an alternate preferred embodiment, the lines from the product to the cooling system may enter the system from beneath the table top TT and beneath the base 25. Another suitable arrangement would be provided on a table top TT with a support member that is in the nature of a cart 31 having wheels (not shown), so that the unit may be wheeled around.

Part of the advantages of the system described is the microprocessor controlled solenoid valves trapping refrigerant responsive to the microprocessor signals as set forth above. Normally on most systems when the system shuts down, the pressure differential will bleed back down to equilibrium, and in a normal situation when the system starts up, there is a time lag to drive up pressure in the condenser as the system starts back up. In the system set forth herein, however, by the action of the solenoid shutdown, pressure is maintained and bleed down is avoided. That is to say, there is a “stop action” freeze of the refrigeration cycle which allows an almost instantaneous return to the refrigeration cycle without the necessity of loading up the condenser.

While the subject of this specification has been described in connection with one or more exemplary embodiments, it is not intended to limit the claims to the particular forms set forth. On the contrary, the appended claims are intended to cover such alternatives, modifications and equivalents as may be included within their spirit and scope.

What is claimed is:

1. A beverage cooling dispensing system comprising:
a compressor, an condenser, and a cold plate;
a liquid line valve fluidly disposed between the condenser and the cold plate;
a liquid evaporator valve fluidly disposed between the cold plate and the compressor; and
a processor configured to alter function of the compressor to maintain a pressure in the condenser when the liquid line valve and the liquid evaporator valve are closed.

2. The system of claim 1, further comprising:
a first transducer positioned to detect a first value along a first refrigerant line between the compressor and the condenser; and
a second transducer positioned to detect a second value along a second refrigerant line between the cold plate and the compressor.

3. The system of claim 2, wherein the processor is further configured to:
compare first and second values with a first and second set points, respectively;
close the liquid line valve and the liquid evaporator valve when the first value reaches the first set point; and
deactivate the compressor when the second value reaches the second set point such that the pressure at the condenser is maintained when the liquid line valve and the liquid evaporator valve are closed.

4. The system of claim 1, wherein the first value is a pressure value.

5. The system of claim 1, wherein the second value is at least one of followings: a pressure value and a temperature value.

6. The system of claim 4, wherein the first set point is between 60 psi and 40 psi.

7. The system of claim 5, wherein the second set point is between 10 psi and 35 psi.

8. The system of claim 2, wherein the processor is further configured to:
compare the first value with a third set point; and
activate the compressor when the first value reaches the third set point.

9. The system of claim 8, wherein the third set point is between 70 psi and 80 psi.

10. The system of claim 8, wherein the processor is further configured to open the liquid line valve and the liquid evaporator valve when the first value reaches the third set point.

11. The system of claim 3, wherein the processor is configured to close the liquid line valve and the liquid evaporator valve is performed fast enough such that substantially no refrigerants are left in an accumulator after the liquid line valve and the liquid evaporator valve are closed.

12. A method of controlling a refrigeration system, wherein the refrigeration system comprises a compressor, a condenser, a cold plate, a liquid line valve, a liquid evaporator valve, the method comprising a step of:
altering function of the compressor to maintain a pressure in the condenser when the liquid line valve and the liquid evaporator valve are closed.

13. The method of claim 12, further comprising steps of:
receiving a first value from a first transducer positioned to detect a first value along a first refrigerant line between the compressor and the condenser;
receiving a second value from a second transducer positioned detect a second value along a second refrigerant line between the cold plate and the compressor; and
comparing the first and second values with a first and second set points.

14. The method of claim 13, further comprising steps of:
closing the liquid line valve and the liquid evaporator valve when the first value reaches the first set point; and
deactivating the compressor when the second value reaches the second set point such that the pressure at the condenser is maintained during the liquid line valve and the liquid evaporator valve are closed.

15. The method of claim 13, further comprising steps of:
comparing the first value with a third set point; and
activating the compressor when the first value reaches the third set point.

16. The method of claim 15, further comprising a step of opening the liquid line valve and the liquid evaporator valve when the first value reaches the third set point.

17. The method of claim 13, wherein the first and second values are pressure values.

18. The method of claim 13, wherein the second value is a temperature value.

19. The method of claim 13, wherein the first set point is greater than the second set point.

20. The method of claim 14, wherein the refrigeration system further comprising an accumulator and wherein the closing the liquid line valve and the liquid evaporator valve is fast enough such that substantially no refrigerants are left in the accumulator after the liquid line valve and the liquid evaporator valve are closed.
